(19) United States
(12) Patent Application Publication
(10) Pub. No.: US 2022/0198844 A1
(43) Pub. Date: Jun. 23, 2022

(54) SYSTEM FOR DETERMINING THE TIRE CONDITION OF A VEHICLE TIRE

(71) Applicant: AUDI AG, Ingolstadt (DE)

(72) Inventor: Lukas ROTTKAMP, Olching (DE)

(73) Assignee: AUDI AG, Ingolstadt (DE)

(21) Appl. No.: 17/603,147

(22) PCT Filed: Nov. 26, 2019
(86) PCT No.: PCT/EP2019/082555

§ 371 Date: Oct. 12, 2021

(30) Foreign Application Priority Data
Apr. 17, 2019 (DE) 10 2019 205 545.1

(51) Int. Cl. G07C 5/08; B60C 23/04; B60C 11/24; B60C 23/20; G07C 5/04; G07C 5/00

(52) U.S. Cl. CPC G07C 5/0825; B60C 23/0493; B60C 11/246; B60C 23/0474; G07C 5/008; B60C 23/0488; B60C 23/20; G07C 5/04; B60C 23/0479

(57) ABSTRACT

The invention relates to a system for determining the tire condition of a vehicle tire in a vehicle, said system comprising a number of sensors, which detect measurement values (m₁, m₂, m₃) relevant to the tire condition, and a device for recording data and transmitting data, said device having a signal connection to the sensors on the input side. According to the invention, the signal output of the device has a preferably wireless signal connection to a readout unit, and the device generates actual tire parameters on the basis of the detected measurement values (m₁, m₂, m₃) and directs said actual tire parameters to the readout unit.

### FIELD

The invention relates to a system for determining the tire condition of a vehicle tire in a vehicle.

### BACKGROUND

The condition of a vehicle tire is currently often checked manually, for example, by visual checking with respect to age, damage, and measurement of the profile depth by a corresponding measuring tool. In some vehicles, an automatic detection of an air loss by tire pressure sensors or an indirect estimating method for ascertaining tire parameters is additionally known. Such a manual check of vehicle tires is uncomfortable. Moreover, the tire check is often forgotten.

Furthermore, many tire parameters are not detected, for example, the maximum temperature endured by a tire.

A generic system for determining the tire condition of a vehicle tire has a number of sensors which detect measurement values relevant with respect to the tire condition. Moreover, the system has a device for data recording and data transfer which has a signal connection to the sensors on the input side.

A vehicle tire having integrated conductor tracks is known from WO 2018/095615 A. A pneumatic vehicle tire and a method for electronically equipping the pneumatic vehicle tire are known from EP 3 287 304 A1. A tire monitoring device is known from DE 10 2009 008 350 B4. A tire condition monitoring device is known from DE 10 2008 014 547 A1.

The object of the invention is to provide a system for determining the tire condition of a vehicle tire in which the current tire condition can be estimated or ascertained in a structurally simple and operationally reliable manner.

### SUMMARY

According to the invention, the device having a signaling connection to the sensors has a preferably wireless signal connection with its signal output to a readout unit. The device can generate actual tire parameters on the basis of the sensorially detected measurement values and conduct them to the readout unit.

The device for data recording and data transfer can be attached on the tire or on the rim of the vehicle wheel. This device can be permanently attached (for example, already introduced into the tire during the production of the tire) or attached semi-permanently or temporarily, for example, using a suitable adhesive bonding method.

Accurate knowledge about the service life of a tire results by means of the invention. An increase in safety can thus result. Moreover, the invention enables custom-tailored decisions with respect to the tire, whereby operating costs can be saved. This is particularly relevant in the case of comparatively expensive special tires (for example, in mining, agriculture, or in motorsports).

In one technical implementation, the device can be supplied with the supply voltage required for the operation via a battery or a rechargeable battery and/or a device located on the tire for obtaining energy (for example mechanically via the rotation or acceleration change of the wheel or a temperature gradient) and/or a device on the vehicle (for example contactless transfer via induction) and/or another device.

With the aid of (for example, commercially available) sensors, the device can detect the current values of at least a subset of the following measured variables, in particular all measured variables, continuously, periodically, on request, or in another way, as follows
rotational angle of the tire
temperature of outside air, tire gas, and/or tread
absolute or relative tire internal pressure
air pressure and/or ambient humidity outside the tire
moisture outside the tire (for example measuring the conductivity of the tread)
rotational velocity of the tire around transverse axis (that is to say, revolutions of the tire per unit of time)
rotational velocity of the wheel around a vertical axis (steering movements)
acceleration of the wheel in the transverse direction (cornering, lateral slipping)
acceleration of the wheel in the longitudinal direction (acceleration or braking of the vehicle)
acceleration of the wheel in the vertical direction (retraction of the wheel)

These sensorially detected measurement values can be stored on a storage unit integrated in the device or connected to the device. Alternatively or additionally, these may be transmitted continuously, periodically, on request, or in another way via a transmitting unit integrated in the device or connected to the device to a vehicle-side receiving component, another device (for example, smart phone or readout device in a workshop), and/or via the Internet to a server. This transmission advantageously takes place wirelessly, for example, via near field communication (RFID), Bluetooth, WLAN, or the mobile wireless network.

In addition, at least a subset of the following tire condition variables (in particular all tire condition variables) is additionally maintained in the device, which can also be transferred in this way:
age of the tire
total operating time of the tire
storage time and storage temperature
curve of the usage profile (“course of life” of the tire, for example including storage time periods)
number of the previous tire revolutions
maximal values of the measurement values
minimal values of the measurement values
average values of the measurement values or their distributions (for example histograms)

Alternatively, these values can be calculated on a connected device (for example by the onboard computer of the vehicle) on the basis of the measurement values.

Items of information about the condition of the tire, in particular whether it is still roadworthy or has to be replaced, can also be calculated by evaluation software in or outside the device by a suitable method (for example, comparison to the permitted operating specifications of the tire and/or typical patterns for perfect or imperfect tires). It can also be calculated whether it is still capable of retreading. In particular, the current profile depth can be estimated by a suitable method (for example, with the aid of a tire wear model).

These items of information can be conveyed to the vehicle driver and/or another person outside the vehicle (for example in fleet management), for example via the vehicle display or a speech output. In particular, a warning can be output in the case of worn-out tires. This can also be reported via a suitable transmitting unit automatically to a central location, for example a server of the fleet management, so that, for example, a maintenance appointment for the vehicle can be created.

Depending on the functional scope, the device can be designed in various scopes. In its simplest form, only a single value, for example, the temperature, is measured and read out via near field communication (RFID). The required energy is advantageously also provided via near field communication in this case, so that a separate power supply of the device is not necessary. In this scope, the device is similar to a sticker or a small chip.

In the case of very large functional scope, the device is designed as a “mini PC” and is equipped, for example, with a modern operating system. A suitable housing and possibly a cooling device is then required here.

Aspects of the invention are described in detail hereinafter: The readout unit can thus be a workshop-side readout device, a vehicle-side receiving component (that is to say a vehicle display or a vehicle-side speech output) for the vehicle user. Alternatively, the readout unit can also be a readout device for a person outside the vehicle.

In one technical implementation, a data memory can be associated with the device, in which the actual tire parameters can be input and stored. The data memory can have a preferably wireless signal connection to the readout unit on the output side to read out the actual tire parameters stored in the data memory into the readout unit.

With regard to the most accurate possible estimation of the current tire condition, it is preferred if a calculating unit is associated with the device. Tire condition variables correlating thereto can then be derived from the sensorially detected measurement values with the aid of the calculating unit. According to the invention, actual tire parameters are preferably understood as both these tire condition variables and also the sensorially acquired measurement values.

In one refinement of the invention, an evaluation unit can be associated with the device. A current tire condition can be ascertained or estimated by a suitable method with the aid of the evaluation unit. In a specific embodiment variant, a target value/actual value comparison can take place in the evaluation unit, in which at least one actual tire parameter is compared to a corresponding target value from, for example, a permitted tire specification. The target values of the permitted tire specification can be stored in the evaluation unit.

With the aid of the evaluation unit, it can preferably be ascertained whether the tire is roadworthy, not roadworthy, or still suitable for a tire retreading.

Alternatively or additionally, the evaluation unit can be a tire wear model unit. With the aid of this, a current profile depth of the tire can be ascertained on the basis of actual tire parameters, and without providing a profile depth sensor.

The device is preferably installed permanently, semi-permanently, or temporarily, for example by means of an adhesive bonding method, on the tire or on the rim of the vehicle wheel.

### BRIEF DESCRIPTION OF THE FIGURES

Exemplary embodiments of the invention are described hereinafter on the basis of the appended figures.

In the figures:

FIG. 1 shows an enlarged cross-sectional view of a vehicle tire having device installed thereon;

FIG. 2 shows a system for determining the tire condition as a block circuit diagram according to a first exemplary embodiment;

FIG. 3 a view corresponding to FIG. 2 according to a second exemplary embodiment.

FIG. 4 a view corresponding to FIG. 2 according to a third exemplary embodiment.

### DETAILED DESCRIPTION

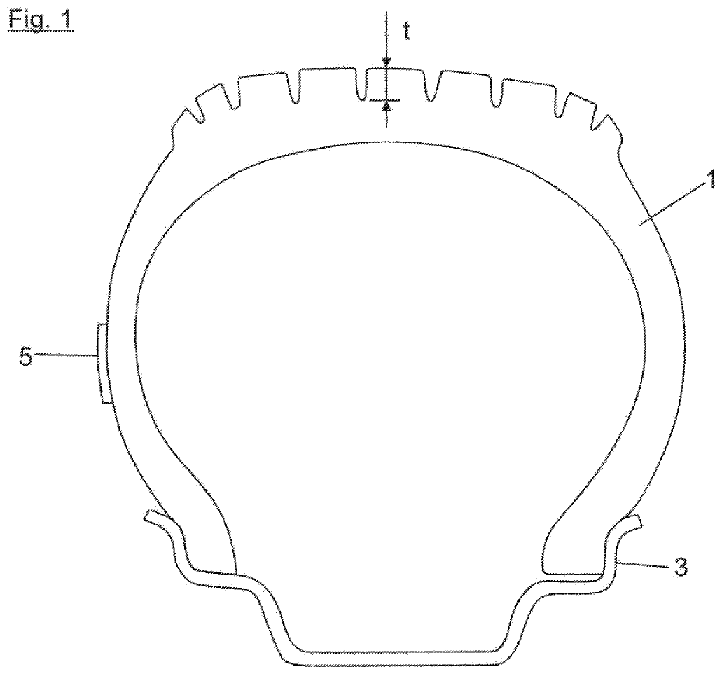

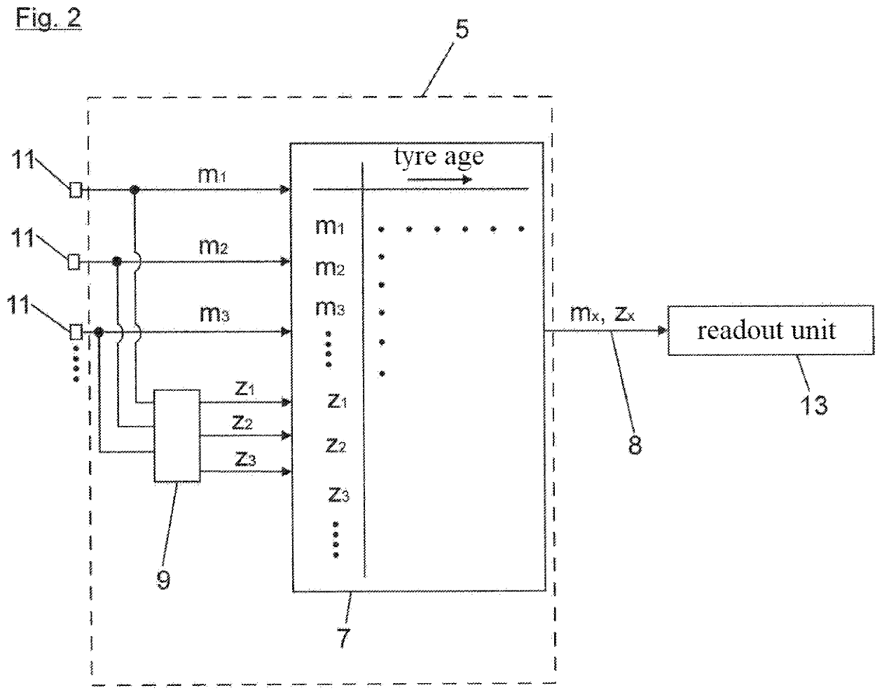

FIG. 1 shows an enlarged cross-sectional view of a vehicle wheel having a tire 1, which is embedded in a rim 3. On its radial outer tread, the tire 1 has a profile having a profile depth t. A device 5 is adhesively bonded on a side wall of the tire 1. The device 5 is part of a system described on the basis of FIG. 2 for determining the tire condition of the vehicle tire. Data transfer and data recording take place in this system in the device 5.

The system for determining the tire condition is described hereinafter on the basis of the block circuit diagram shown in FIG. 2. The block circuit diagram is prepared with regard to simple comprehension of the invention. Therefore, FIG. 2 is merely a rough simplified illustration which does not reflect a realistic software architecture of the system. Thus, in FIG. 2 the device 5 has a data memory 7 and a calculating unit 9 as program components. In FIG. 2, the device 5 has a signal connection on the input side to a plurality of sensors 11, which detect measurement values m₁, m₂, m₃ relevant with respect to the tire condition. The measurement values m₁, m₂, m₃ are input into the data memory 7 and stored therein. The calculating unit 9 derives the tire condition variables z₁, z₂, z₃, which correlate with the respective measurement values m₁, m₂, and m₃, from the sensorially detected measurement values m₁, m₂, m₃. Both the calculated tire condition variables z₁, z₂, z₃ and also the sensorially detected measurement values m₁, m₂, m₃ form actual tire parameters in the meaning of the invention, on the basis of which the current tire condition is determinable.

The tire condition variables z₁, z₂, z₃ ascertained in the calculating unit 9 and the sensorially detected measurement values m₁, m₂, m₃ are stored in the data memory 7 in FIG. 2 and possibly read out therefrom in a readout unit 13. The readout unit 13 has a wireless signal connection 8 in FIG. 1 to the signal output of the data memory 7, for example, via a near field communication (RFID), Bluetooth, WLAN, or via the mobile wireless network. The readout unit 13 can preferably be a workshop-side readout device or a vehicle-side receiving component, such as a vehicle display or a vehicle-side speech output. Alternatively thereto, the readout device can also be positioned in consideration of fleet management, outside the vehicle at a control centre of the fleet management.

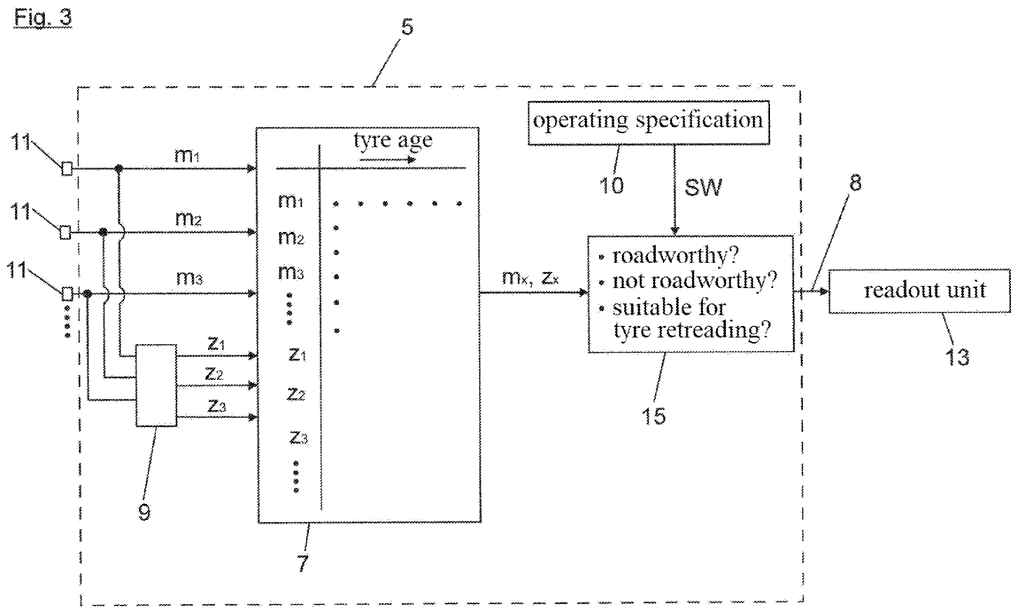

FIG. 3 shows the system for determining the tire condition of the vehicle tire according to a second exemplary embodiment, the fundamental structure and functionality of which correspond to the first exemplary embodiment shown in FIGS. 1 and 2. In addition to the first exemplary embodiment, the device 5 has an evaluation unit 15, by means of which a tire condition can be ascertained. In FIG. 3, this takes place, for example, by means of a target value/actual value comparison, in which at least one actual tire parameter mₓ, zₓ, is read out from the data memory 7 and compared to a corresponding target value SW of a permitted tire specification 10, which is stored in the device 5. On the basis of this comparison, the evaluation unit 15 determines whether the tire is roadworthy, is not roadworthy, or is still suitable for a tire retreading. The tire condition ascertained in the evaluation unit 15 is conducted as a corresponding signal via the wireless signal connection 8 to the readout unit 13.

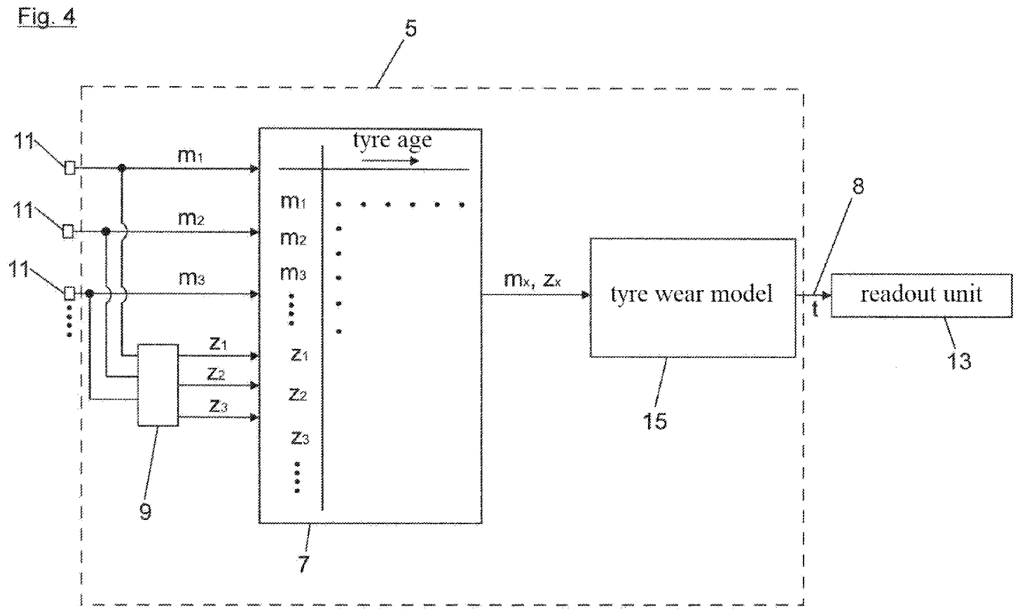

Alternatively thereto, a third exemplary embodiment is shown in FIG. 4. Accordingly, a tire wear model is stored in the evaluation unit 15. With the aid of the tire wear model stored in the evaluation unit 15, a current profile depth t of the tire 1 is ascertained on the basis of the actual tire parameters mₓ, zₓ, read out from the data memory 7, and without providing a special profile depth sensor. The current profile depth t ascertained in the evaluation unit 15 is conducted as a corresponding signal via the wireless connection 8 to the readout unit 13.

### LIST OF REFERENCE SIGNS

1 tire
3 rim
5 device
7 data memory
9 calculating unit
10 tire operating specification
11 sensors
13 readout unit
15 evaluation unit
t profile depth
SW target value

1-10. (canceled)

11. A system for determining the tire condition of a vehicle tire in a vehicle, having a number of sensors, which detect measurement values (m₁, m₂, m₃) relevant with respect to the tire condition, and a device for data recording and data transfer, which has a signal connection on the input side to the sensors, wherein the device has a preferably wireless signal connection to a readout unit with its signal output, and the device generates actual tire parameters on the basis of the detected measurement values (m₁, m₂, m₃) and directs them to the readout unit.

12. The system as claimed in claim 11, wherein with the aid of the sensors, the device detects the current values of at least a subset of the following measurement values, in particular all measurement values, continuously, periodically, on request, or in another manner, as follows
rotational angle of the tire
temperature of outside air, tire gas, and/or tread
absolute or relative tire internal pressure
air pressure and/or ambient humidity outside the tire
moisture outside the tire, for example by measuring the conductivity of the tread
rotational velocity of the tire around transverse axis, that is to say revolutions of the tire per unit of time
rotational velocity of the wheel around a vertical axis, that is to say steering movements
acceleration of the wheel in the transverse direction during cornering and/or during lateral slipping
acceleration of the wheel in the longitudinal direction during acceleration or braking of the vehicle
acceleration of the wheel in the vertical direction during retraction or extension of the wheel.

13. The system as claimed in claim 11, wherein a calculating unit is assigned to the device, by which correlating tire condition variables (z₁, z₂, z₃) are derivable from the sensorially detected measurement values (m₁, m₂, m₃), and by the calculating unit, at least a subset of the following tire condition variables, in particular all tire condition variables, are ascertained:
age of the tire
total operating time of the tire
storage time and storage temperature
curve of the tire usage profile, that is to say the tire course of life including storage time periods
number of the previous tire retreads
maximal values of the measurement values
minimal values of the measurement values
average values of the measurement values or their distributions;
and both the tire condition variables (z₁, z₂, z₃) and also the sensorially detected measurement values (m₁, m₂, m₃) form the actual tire parameters.

14. The system as claimed in claim 11, wherein a data memory is associated with the device, in which the actual tire parameters (m₁, m₂, m₃, z₁, z₂, z₃) can be input and stored, and the data memory has a wireless signal connection on the output side to the readout unit to read out the stored actual tire parameters in the readout unit.

15. The system as claimed in claim 11, wherein an evaluation unit is associated with the device, by which a tire condition is ascertainable by a suitable method, and it is ascertainable by the evaluation units whether the tire is roadworthy, not roadworthy, or still suitable for a tire retreading.

16. The system as claimed in claim 15, wherein a target value/actual value comparison takes place in the evaluation unit, in which at least one actual tire parameter is compared to a corresponding target value (SW) from a permitted tire specification.

17. The system as claimed in claim 15, wherein the evaluation unit is a tire wear model unit, by which a current profile depth (t) of the tire is ascertainable on the basis of actual tire parameters without providing a profile depth sensor.

18. The system as system as claimed in claim 11, wherein the device is attached permanently, semi-permanently, or temporarily by an adhesive bonding method, on the tire or on the rim of the vehicle tire, and/or in that the device can be supplied with electrical energy via a battery or a rechargeable battery and/or a device located on the vehicle wheel for obtaining energy and/or via a device on the vehicle and/or via another device in contactless transmission via induction.

19. The system as claimed in claim 11, wherein the calculating unit, the evaluation unit, and the data memory are integrated as program components in the device.

20. The system as claimed in claim 11, wherein the readout unit is a workshop-side readout device, such as a vehicle-side receiving component having a display or a speech output for the vehicle user, and/or a readout device for a person outside the vehicle in a fleet management, and the display is activatable by the readout unit directly or by an interconnected unit.

21. The system as claimed in claim 12, wherein a calculating unit is assigned to the device, by which correlating tire condition variables (z₁, z₂, z₃) are derivable from the sensorially detected measurement values (m₁, m₂, m₃), and the calculating unit, at least a subset of the following tire condition variables, in particular all tire condition variables, are ascertained:
age of the tire
total operating time of the tire
storage time and storage temperature
curve of the tire usage profile, that is to say the tire course of life including storage time periods
number of the previous tire retreads
maximal values of the measurement values
minimal values of the measurement values
average values of the measurement values or their distributions;
and both the tire condition variables (z₁, z₂, z₃) and also the sensorially detected measurement values (m₁, m₂, m₃) form the actual tire parameters.

22. The system as claimed in claim 12, wherein a data memory is associated with the device, in which the actual tire parameters (m₁, m₂, m₃, z₁, z₂, z₃) can be input and stored, and the data memory has a wireless signal connection on the output side to the readout unit to read out the stored actual tire parameters in the readout unit.

23. The system as claimed in claim 13, wherein a data memory is associated with the device, in which the actual tire parameters (m₁, m₂, m₃, z₁, z₂, z₃) can be input and stored, and the data memory has a wireless signal connection on the output side to the readout unit to read out the stored actual tire parameters in the readout unit.

24. The system as claimed in claim 12, wherein an evaluation unit is associated with the device, by which a tire condition is ascertainable by a suitable method, and it is ascertainable by the evaluation units whether the tire is roadworthy, not roadworthy, or still suitable for a tire retreading.

25. The system as claimed in claim 13, wherein an evaluation unit is associated with the device, by which a tire condition is ascertainable by a suitable method, and it is ascertainable by the evaluation units whether the tire is roadworthy, not roadworthy, or still suitable for a tire retreading.

26. The system as claimed in claim 14, wherein an evaluation unit is associated with the device, by which a tire condition is ascertainable by a suitable method, and it is ascertainable by the evaluation units whether the tire is roadworthy, not roadworthy, or still suitable for a tire retreading.

27. The system as claimed in claim 16, wherein the evaluation unit is a tire wear model unit, by which a current profile depth (t) of the tire is ascertainable on the basis of actual tire parameters without providing a profile depth sensor.

28. The system as system as claimed in claim 12, wherein the device is attached permanently, semi-permanently, or temporarily by an adhesive bonding method, on the tire or on the rim of the vehicle tire, and/or in that the device can be supplied with electrical energy via a battery or a rechargeable battery and/or a device located on the vehicle wheel for obtaining energy and/or via a device on the vehicle and/or via another device in contactless transmission via induction.

29. The system as system as claimed in claim 13, wherein the device is attached permanently, semi-permanently, or temporarily by an adhesive bonding method, on the tire or on the rim of the vehicle tire, and/or in that the device can be supplied with electrical energy via a battery or a rechargeable battery and/or a device located on the vehicle wheel for obtaining energy and/or via a device on the vehicle and/or via another device in contactless transmission via induction.

30. The system as system as claimed in claim 14, wherein the device is attached permanently, semi-permanently, or temporarily by an adhesive bonding method, on the tire or on the rim of the vehicle tire, and/or in that the device can be supplied with electrical energy via a battery or a rechargeable battery and/or a device located on the vehicle wheel for obtaining energy and/or via a device on the vehicle and/or via another device in contactless transmission via induction.
